(19) United States
(12) Patent Application Publication
(10) Pub. No.: US 2011/0011247 A1
(43) Pub. Date: Jan. 20, 2011

(54) MUSICAL COMPOSITION DISCRIMINATION APPARATUS, MUSICAL COMPOSITION DISCRIMINATION METHOD, MUSICAL COMPOSITION DISCRIMINATION PROGRAM AND RECORDING MEDIUM

(75) Inventors: Yasuteru Kodama, Sayama (JP); Shinichi Gayama, Ageo (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/918,962

(22) PCT Filed: Feb. 22, 2008
(86) PCT No.: PCT/JP2008/053031

§ 371 Date: Aug. 23, 2010

(51) Int. Cl. G10H 1/06

(52) U.S. Cl. 84/622

(57) ABSTRACT

A musical composition discrimination apparatus, a musical composition discrimination method, a musical composition discrimination program and a recording medium, provide a musical composition and information thereon as desired by a user. In the musical composition discrimination apparatus, a system control unit 4 calculates from the musical composition data a music interval power-additional level corresponding to a harmony provided by the musical composition, calculates a harmony clearness indicative of a degree as to whether the harmony is acoustically clearly audible or not, based on the calculated music interval power-additional level, and discriminates an impression of the musical composition based on the harmony clearness.

### TECHNICAL FIELD

The present invention relates to a technical field of a musical composition discrimination apparatus and the other that permit discrimination of an impression of a musical composition.

### BACKGROUND OF THE INVENTION

As a way to search a musical composition, there has been proposed a way to discriminate an impression of a musical composition and then search the musical composition based on the impression thereof.

An “impression” of a musical composition means an impression on the musical composition received by a person who have listened to it, and for example a musical composition, which has a faster pace (tempo) and is composed of high-pitched sounds, provides a light and cheerful feeling.

The musical composition has been characterized by the impression and such an impression has been utilized to search the musical composition.

Patent Document No. 1 discloses an invention in which the structure of a musical composition is analyzed by classifying kinds of chords included in the musical composition.

Patent Document No. 1: Japanese Patent Provisional Publication No. H6-290574

### DISCLOSURE OF THE INVENTION

### Subject to be Solved by the Invention

However, even if chords are used in a musical composition, a simultaneous use of the other seriously distortional sounds or beating sounds (i.e., distortional sounds of an electric guitar, a bass guitar or a drum) may make the chords unclearly audible. Such an impression of the musical composition provides an impression of full of variety and intensiveness and exciting. Even when the search of an impression of a musical composition was made using an index of formation of chords included in the musical composition, it was not possible to select the musical composition as desired by a user.

The invention of Patent Document No. 1 permits an extraction of similarity in a chord formation of the musical composition, however, it is not possible to know the impression of this musical composition. Even when a search for the musical composition providing comfort and calmness was made based on the chord formation included in the musical composition, it was not possible to select the musical composition as desired by a user.

A subject to be solved by the invention is to solve the above-mentioned problems to provide a musical composition discrimination apparatus, a musical composition discrimination method, a musical composition discrimination program and a recording medium, which permit to provide a musical composition and information thereon as desired by a user.

### Means to Solve the Subject

In order to solve the above-mentioned problems, the musical composition discrimination apparatus of the present invention claimed in claim 1, comprises: a music interval power-additional level calculation unit that calculates a music interval power-additional level from musical composition data as inputted; a harmony clearness calculation unit that calculates, based on a music interval power as calculated, a harmony clearness indicative of a degree as to whether a harmony is acoustically clearly audible or not; and a musical impression discrimination unit that utilizes the harmony clearness to discriminate an impression of the musical composition.

The musical composition discrimination method of the present invention claimed in claim 5 comprises: a music interval power-additional level calculation step for calculating a music interval power-additional level from musical composition data as inputted; a harmony clearness calculation step for calculating, based on a music interval power-additional level as calculated, a harmony clearness indicative of a degree as to whether a harmony is acoustically clearly audible or not; and a musical impression discrimination step for utilizing the harmony clearness to discriminate an impression of the musical composition.

The musical composition discrimination program of the present invention claimed in claim 6 causes a computer included in a musical composition discrimination apparatus to function as: a music interval power-additional level calculation unit that calculates a music interval power-additional level from musical composition data as inputted; a harmony clearness calculation unit that calculates, based on a music interval power as calculated, a harmony clearness indicative of a degree as to whether a harmony is acoustically clearly audible or not; and a musical impression discrimination unit that utilizes the harmony clearness to discriminate an impression of the musical composition.

### BRIEF DESCRIPTION OF THE DRAWINGS

FIG. 1 shows musical composition data (signal) after an Fast Fourier Transform and a music interval power-additional level “ANP(p)”, and FIG. 1(A) is a drawing showing the musical composition data (signal) after the Fast Fourier Transform and FIG. 1(B) is a drawing showing the music interval power-additional level “ANP(p)”;

FIG. 2(A) shows images based on which there are calculated transitions of the music interval power-additional levels in the respective music intervals in a temporal axis direction in a predetermined period of time of the musical composition data, and FIG. 2(A)-t1 is a drawing showing the music interval power-additional levels in the respective music intervals in a small amount of time “t1”, FIG. 2(A)-t2 is a drawing showing the music interval power-additional levels in the respective music intervals in a small amount of time “t2”, and FIG. 2(A)-t is a drawing showing the music interval power-additional levels in the respective music intervals in a small amount of time “t”;

FIG. 2(B) is a drawing in which the music interval power-additional levels in the respective music intervals are shown with four parameters;

FIG. 2(C) is a drawing showing a transition of a harmony clearness (CCV) in a temporal axis direction;

FIG. 3(A) shows images based on which there are calculated transitions of the music interval power-additional levels in the respective music intervals in a temporal axis direction in a predetermined period of time of the musical composition data, and FIG. 3(A)-t1 is a drawing showing the music interval power-additional levels in the respective music intervals in a small amount of time “t1”, FIG. 3(A)-t2 is a drawing showing the music interval power-additional levels in the respective music intervals in a small amount of time “t2”, and FIG. 3(A)-t is a drawing showing the music interval power-additional levels in the respective music intervals in a small amount of time “t”;

FIG. 3(B) is a drawing in which the music interval power-additional levels in the respective music intervals are shown with four parameters;

FIG. 3(C) is a drawing showing a transition of a harmony clearness (CCV) in a temporal axis direction;

FIG. 4 is a block diagram showing the general configuration example of an information reproduction apparatus “S”;

FIG. 5 is a flowchart showing operation of the information reproduction apparatus “S”;

FIG. 6 is a flowchart showing discrimination of an impression of the musical composition based on the harmony clearness and a lower beat level;

FIG. 7(A) is a drawing showing a temporal variation of the harmony clearness and the lower beat level of a musical composition “A”;

FIG. 7(B) is a drawing showing a temporal variation of the harmony clearness and the lower beat level of a musical composition “B”;

FIG. 7(C) is a drawing showing a temporal variation of the harmony clearness and the lower beat level of a musical composition “C”;

FIG. 7(D) is a drawing showing a temporal variation of the harmony clearness and the lower beat level of a musical composition “D”;

FIG. 8 is a drawing showing classified impressions utilizing the harmony clearness and the lower beat level;

FIG. 9(A) is a drawing showing values of the harmony clearness and the lower beat level in case where the musical composition “A” is reproduced with a signal power of about “100”;

FIG. 9(B) is a drawing showing values of the harmony clearness and the lower beat level in case where the signal power is decreased to half, i.e., about “50”;

FIG. 10(A) is a drawing showing values of the harmony clearness and the lower beat level in case where the musical composition “A” is reproduced with a signal power of about “20”; and

FIG. 10(B) is a drawing showing values of the harmony clearness and the lower beat level in case where the signal power is increased to double, i.e., about “40”.

### DESCRIPTION OF REFERENCE NUMERALS

1 reproduction processing unit
2 external output unit
3 storage unit
4 system control unit
5 communication unit
S information reproduction/recording apparatus

### BEST MODE FOR CARRYING OUT THE INVENTION

### I) Principle of the Present Invention

The present invention proposes to utilize a “harmony clearness” to discriminate the impression of a musical composition.

In the present invention, the “harmony clearness” is defined as an index indicative of a degree as to whether a harmony is acoustically clearly audible or not.

It has been generally known that a musical composition having acoustically clearly audible harmonies provides clear and beautiful sounds, thus presenting a relaxation impression, which provides a person who have listened to it with comfort and calmness feeling, and on the other hand, a musical composition having no acoustically clearly audible harmonies presents an impression of distortional and powerful sounds. The inventor of the present invention focused the matter that the impression of the musical composition varied depending upon as to whether or not the harmony was acoustically clearly audible, and quantified as the “harmony clearness” a degree as to whether a harmony is acoustically clearly audible or not, and used it as a novel index indicative of an impression of the musical composition, to discriminate the impression of the musical composition based on the value of the harmony clearness.

In particular, in order to quantify the harmony clearness, a power spectrum of the respective music interval is calculated from a musical composition, and a harmony clearness, etc. are calculated based on the power spectrum as calculated, and then an impression of the musical composition is discriminated based on the harmony clearness as calculated.

More specifically, a signal level (amplitude) power spectrum F(n) in a predetermined bandwidth (Hz) is calculated for the musical composition as inputted, by a Fast Fourier Transform, etc., and the respective music interval powers (Hz) are calculated from the calculation results. Then, the respective music interval powers are subjected to a weighting addition processing, thus calculating a “music interval power-additional level”.

Then, a deviation within an octave (a difference from an average value of the respective music interval power-additional levels “ANP(p)” as calculated) is calculated from the “music interval power-additional level”.

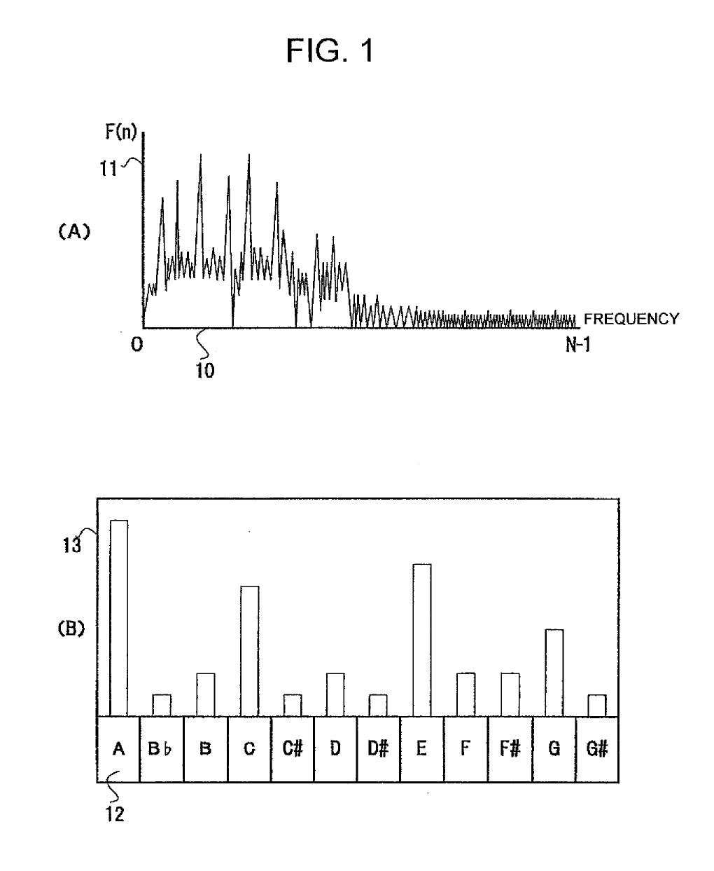

Now, a specific description of calculation results of the harmony clearness for the musical composition will be described with reference to FIGS. 1 to 3. First, a harmony clearness is calculated for a musical composition having an acoustically clearly audible harmony. This musical composition, in which many sound having harmonic components of musical instruments such as a piano, a synthesizer or a string instrument are used, has a characteristic feature of providing a feeling of clearness, beauty or calmness in an acoustic sense, and giving a sweet harmony (e.g., chords) to one's ears.

First, in order to calculate a music interval power, the musical composition data of a musical composition is subjected to a Fast Fourier Transform in an arbitrary point (in a “N” point in this embodiment of the present invention) in a small amount of time (Δt) as an instantaneous time of the musical composition (the results of FFT in this embodiment of the present invention will hereinafter be referred to as “FFT at N points”). Here, the FFT is the Fast Fourier Transform, which is a processing of extracting how many and what frequency component is included in a certain signal. The Fast Fourier Transform is a well known art and the detailed description of it will be omitted. The “points” mean points which respectively represent areas separated by the predetermined bandwidths (Hz) in the whole frequency components of the musical component data. The “N” point means that there exist N-points, which represent the respective areas separated by the “N” bandwidths (Hz).

FIG. 1(A) shows the musical composition data (signal) after the Fast Fourier Transform. The abscissa axis 10 indicates a range of frequency under which the signal as extracted by the Fast Fourier Transform falls, and the ordinate axis 11 indicates a power spectrum F(n) indicative of an energy included by the signal in the respective frequency.

Then, a power of the respective music interval within “M” octaves is calculated. More specifically, the frequency range (Hz) of the FFT at N points as transformed is divided into groups of octave in each of which the respective arbitrary frequency range (Hz) forms the octave (i.e., “M” octaves in the embodiment of the present invention), and the octave as obtained by dividing the frequency range into the groups is further divided into a predetermined number of areas (arbitrary points (Hz)), and then these areas as divided is utilized as indicating the music intervals (Hz), thus calculating the powers of the respective music intervals.

In the embodiment of the present invention, the frequency bandwidth of from 220 Hz to 420 Hz, which serves as the arbitrary frequency range, is divided into the groups of octave, each of the divided groups of octave is divided as the arbitrary point into twelve equal sections in a log scale (a scale display in a frequency characteristic diagram) and then these sections as divided is utilized as indicating the music intervals. In an assumption that the twelfth root of “2” is “k”, a value obtained by multiplying a frequency of a certain music interval by “k” is used as a frequency of the next music interval. More specifically, in the first octave, the music interval “A” is set as “220 Hz”, the music interval “A#”, “233 Hz” (220*k), the music interval “B”, “247 Hz” (220*k̂2), the music interval “C”, “261 Hz” (220*k̂3), and the music intervals “C#”, “D”, “D#”, “E”, “F”, “F#” and “G” being set as the respective increased value in this manner, and the last music interval “G#” is set as “415 Hz” (220*k̂11). In the second octave, the music interval “A” is set as “440 Hz” (220*k̂12=220*2), the music interval “B”, “494 Hz” (440*k̂2), the music interval “C”, “523 Hz” (440*k̂3), and the music intervals “C#”, “D”, “D#”, “E”, “F”, “F#” and “G” being set as the respective increased value in this manner, and the last music interval “G#” is set as “830 Hz” (440*k̂11) in the same manner as described above. In the third octave, the music interval “A” is set as “880 Hz” (440*k̂12=440*2), and the respective music intervals are sequentially set and the respective music interval powers are detected. The whole frequency components extracted through the Fast Fourier Transform is subjected to the same processing.

The music interval may be represented by for example the following formula (1):

NP(m)=F(fpos(m)), m=0 , , , 12*M Formula (1)

Wherein, “F(p)” denotes a power at the FFT point and “fops(m)” denotes the FFT point corresponding to the frequency of the arbitrary music interval “m”, and accordingly, “NP(m)” denotes the music interval power at the arbitrary music interval.

Then, calculation of the music interval power-additional level is made. More specifically, the respective music interval powers as calculated for the respective octaves as described above are subjected to a weighting addition processing (the resultant value being hereinafter referred to as the “music interval power-additional level”). The music interval powers are aggregated within a single octave.

More specifically, this processing may be represented by for example the following formula (2):

$$ANP ( p ) = {\sum }_{i = 0}^{M - 1} W ( i ) NP ( P + M * i ) , p = 0 , … , 11 \qquad Formula ( 2 )$$

Wherein, “p” denotes an arbitrary music interval, and “i” denotes an arbitrary octave range. “W(i)” denotes a weighting. This has a function of preventing adverse effects of noise component in a high frequency bandwidth. There is a large possibility that, for example, the high frequency bandwidth may include a high frequency noise, and a light weighting processing is carried out (i.e., “W (i)” is set as the smaller value.). The conditions for the weighting processing may be set for each of the octaves, and for example, the additional processing may be carried out in each of the octaves having the integer number.

Formula (2) figures out the sum, while carrying out the multiplication processing by the weighting for each of the music intervals, so that the music interval power extending over the arbitrary octaves is aggregated within a single octave. The music interval power-additional level “ANP(p)” is calculated for each of the music intervals in this manner. The music interval power-additional level “ANP(p)” as calculated is used as the power of the respective music intervals.

FIG. 1(B) shows the music interval power-additional level “ANP(p)”. The abscissa axis 12 indicates the respective music intervals, i.e., the music intervals of “A” to “G#” and the ordinate axis 13 indicates the music interval power-additional level “ANP(p)”. Then, the harmony clearness is calculated.

More specifically, deviation of the music interval power as aggregated within the single octave is calculated. In this embodiment of the present invention, the deviation of the music interval power as aggregated within the single octave is used as the harmony clearness “CCV”.

In the following formula (3), there is calculated the harmony clearness, i.e., the deviation as calculated of the music interval power-additional level “ANP(p)” within the single octave (i.e., an integration value of the square of a difference from the average value of the calculated music interval power-additional levels “ANP(p)” of the respective music interval).

$$CCV = ( 1 / 12 ) * {\sum }_{i = 0}^{11} ( ANP ( i ) - {( ( 1 / 12 * {\sum }_{j = 0}^{11} ANP ( j ) ) )}^{2} \qquad Formula ( 3 )$$

When the deviation within the single octave, which serves as the harmony clearness, is large, the music interval power-additional level “ANP(p)”, which forms a harmony (e.g., chords, or the like) included in the single octave is remarkably large and the music interval power-additional level “ANP(p)” the other music intervals becomes small, with the result that a certain harmony is remarkably audible. When the deviation within the single octave is small on the other hand, there is a small difference in the music interval power-additional level “ANP(p)”, with the result that the harmony is not remarkably audible. Therefore, this reveals that the harmony clearness serves as an index indicating a degree as to whether a harmony is acoustically clearly audible or not.

In the above-described embodiment of the present invention, the deviation within the single octave is used in order to calculate the harmony clearness. However, the present invention is not limited only to this embodiment. The harmony clearness means the index indicating a degree as to whether a harmony is acoustically clearly audible or not, and it may serve as an index representing an existence of not only the deviation of the music interval power-additional level, but also distribution of the music interval power-additional level, discrepancy of the music interval power-additional level, a degree of discrepancy or an amount of variation, or an existence of a remarkably large music interval power-additional level.

As an example of characteristic properties of the harmony clearness, the following formula (4) or (5) may be used. Formula (4) has generalized constant terms to omit a calculation of an average value of the music interval power-additional level “ANP(p)”.

$$CCV = P * {\sum }_{i = 0}^{11} {( ANP ( i ) - K )}^{2} \qquad Formula ( 4 )$$

Formula (5) omits the square calculation.

$$CCV = P * {\sum }_{i = 0}^{11} ( \vert ANP ( i ) - K \vert ) \qquad Formula ( 5 )$$

Wherein, “CCV” denotes the harmony clearness.

There may be pointed out some methods, as described below, of improving the accuracy of the harmony clearness.

The number of music intervals of which a harmony is composed is not always constant. The CCV varies depend upon the number of music intervals of which a harmony is composed. A difference between an average value of the music interval powers with a peak and an average value of the other musical interval powers may be used as the harmony clearness as shown in Formula (6). In this formula, “UpAvr” denotes an average value of the music interval powers with a peak and “DnAvr” denotes an average value of the other musical interval powers.

CCV1=UpAvr−DnAvr Formula (6)

The CCV becomes large when the beautiful harmony is clearly audible as described above, but it also comes large when a combination of not-beautiful chords is clearly audible. It cannot be said that the combination of not-beautiful chords is a harmony. In this case, it is necessary to reduce the harmony clearness with the use of a coefficient “X” as shown in Formula (7)

CCV2=X*CCV Formula (7)

In this formula, “X” is within a range of from “0” to “1” and is determined in accordance with a set of music intervals with a peak. In case where the set of music intervals with a peak is chords, which may be called “harmony”, such as a consonance, “X” is determined as a large value. In case where it is chords, which may not be called “harmony”, such as a discordance, “X” is determined as a small value. In case where a set of music intervals with a peak is compared with all the musical theoretical consonances to identify the most feasible consonance, the other music intervals than these consonances may be considered as a noise against a harmony. When the sum of the power of the other music interval than these consonances is large, “X” is set as a small value. When the sum thereof is small, on the other hand, “X” is set as a large value.

Then, transition of the harmony clearness in a temporal axis direction is calculated. The harmony clearness as calculated utilizing Formula (3) is an instantaneous value in the musical composition. Calculation of the harmony clearness in a predetermined part of the musical composition or the entirety thereof makes it possible to discriminate as to what chords form the above-mentioned predetermined part of the musical composition or the entirety thereof, and discriminate as to what impression of the musical composition is to be given by the whole musical composition.

More specifically, the harmony clearness in a predetermined period of time of the musical composition data is calculated and then variation thereof is obtained (i.e., transition of the harmony clearness in a temporal axis is measured).

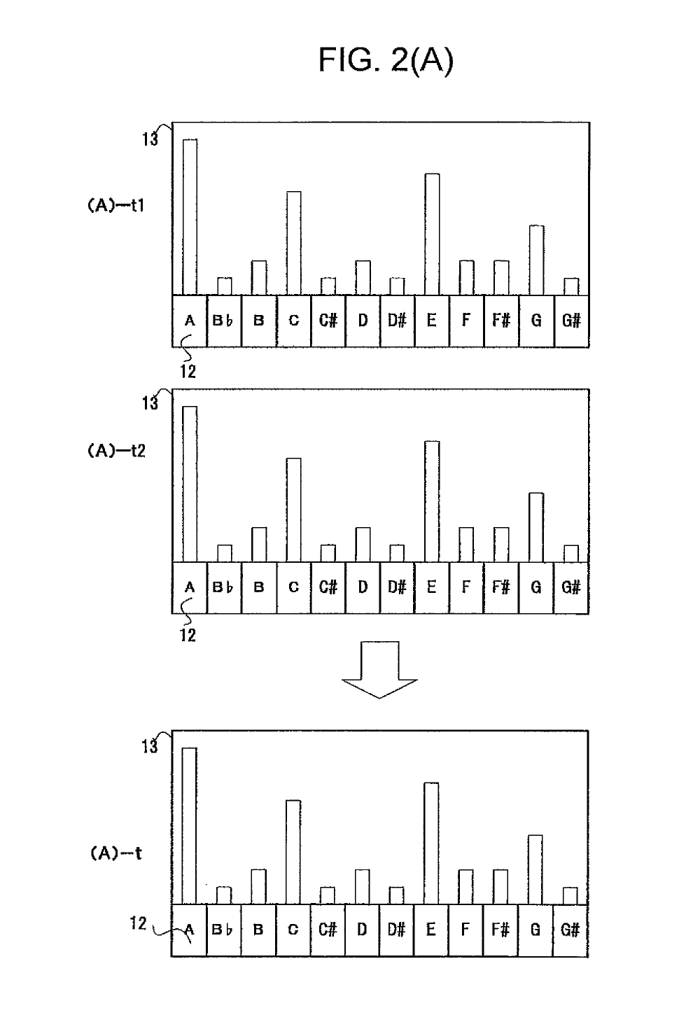

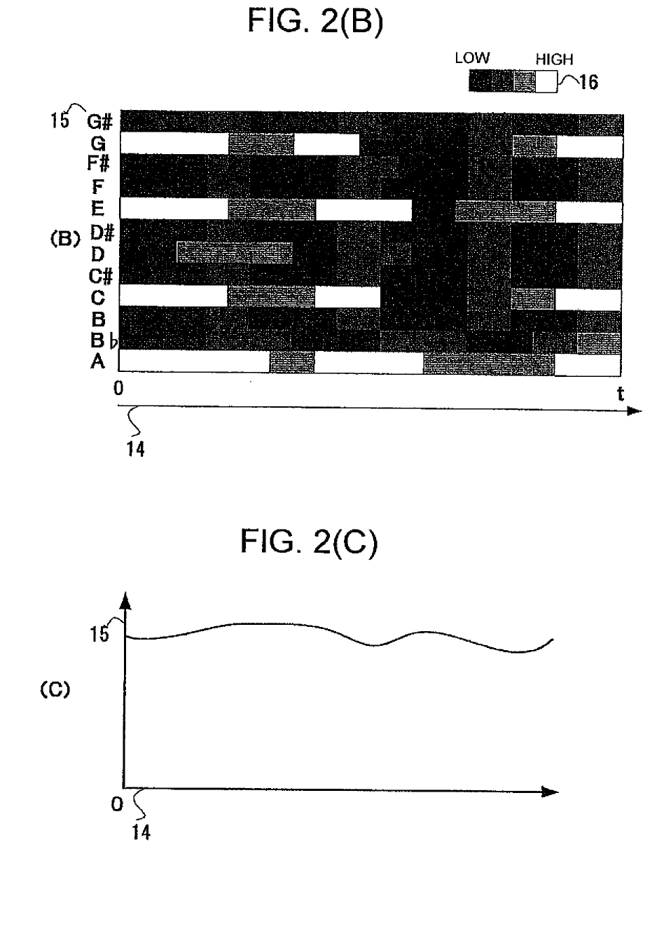

FIGS. 2(A) to (C) indicate the harmony clearness in a temporal axis.

First, there are calculated transitions of the music interval power-additional levels in the respective music intervals in a temporal axis direction in a predetermined period of time of the musical composition data. FIG. 2(A) shows images based on which there are calculated transitions of the music interval power-additional levels in the respective music intervals in a temporal axis direction in a predetermined period of time of the musical composition data. In FIG. (A)-t1, the music interval power-additional levels in the respective music intervals in a small amount of time “t1” is calculated utilizing for example Formula (3), and such a calculation is made until a small amount of time “t”. There are calculated the transitions of the music interval power-additional levels in the respective music intervals in a temporal axis direction from a predetermined period of time of from “t1” to “t” in this manner.

FIG. 2(B) shows the music interval power-additional levels in the respective music intervals with four parameters. The abscissa axis 14 indicates a time, and indicates a period of time of from the small amount of time “t1” to “t”. The ordinate axis 15 indicates the respective music intervals. The music interval power-additional levels are indicated based on a contrasting density display 16, a lighter indication shows a high music interval power-additional level and a darker indication shows a low music interval power-additional level.

Then, transition of the harmony clearness in a temporal axis is calculated. The transition of the harmony clearness in the temporal axis is obtained by calculating, from the calculation results of the music interval power-additional levels in the respective music intervals in the small amount of time of the musical composition data, the harmony clearness in the corresponding small amount of time with the use of for example Formula (3). Calculation of the harmony clearness is carried out in the predetermined period of time of from the small amount of “t1” to “t”, thus calculating the transition of the harmony clearness in the temporal axis direction. FIG. 2(C) shows the transition of the harmony clearness (CCV) in the temporal axis direction. The abscissa axis 15 indicates magnification of the harmony clearness.

It can be predicted from FIG. 2(B) that the music interval power-additional level ANP(p) of chords in a certain music interval is remarkably high and the music interval power-additional level ANP(p) of chords in the other music interval becomes low, and as a result, a standard deviation of the music interval power-additional level in the respective music intervals of the musical composition data becomes larger. FIG. 2(C) shows as predicted that the calculation results of the harmony clearness of the standard deviation of the music interval power-additional level in the respective music intervals of the musical composition data also larger.

After the calculation of the harmony clearness for the musical composition having a relaxation impression providing comfort and calmness feeling, the harmony clearness is indicated as a high value. It is confirmed that the musical composition having the high harmony clearness includes a combination of chords, which is acoustically audible, and the above-described calculation results coincide with the impression of chords of the musical composition in an acoustic sense with which the musical composition is actually listened to.

Then, the harmony clearness for the musical composition having no acoustically clearly audible chords is calculated. In this musical composition, there are used many sounds, which include non-harmonic components or noise components, of musical instruments such as percussion instrument or electric instrument (e.g., an electric guitar” permitting to produce effect sounds, and there is provided an impression of furiousness, loudness or aggressiveness given to an audible sense, resulting in less harmonic feeling (the chords not being acoustically audible) and highlighted beat and rhythm.

As the method for calculating it, the same calculation methods as those for calculating the transition of the high harmony clearness in the temporal axis as described above (FIGS. 1(A) to (C)) are applied.

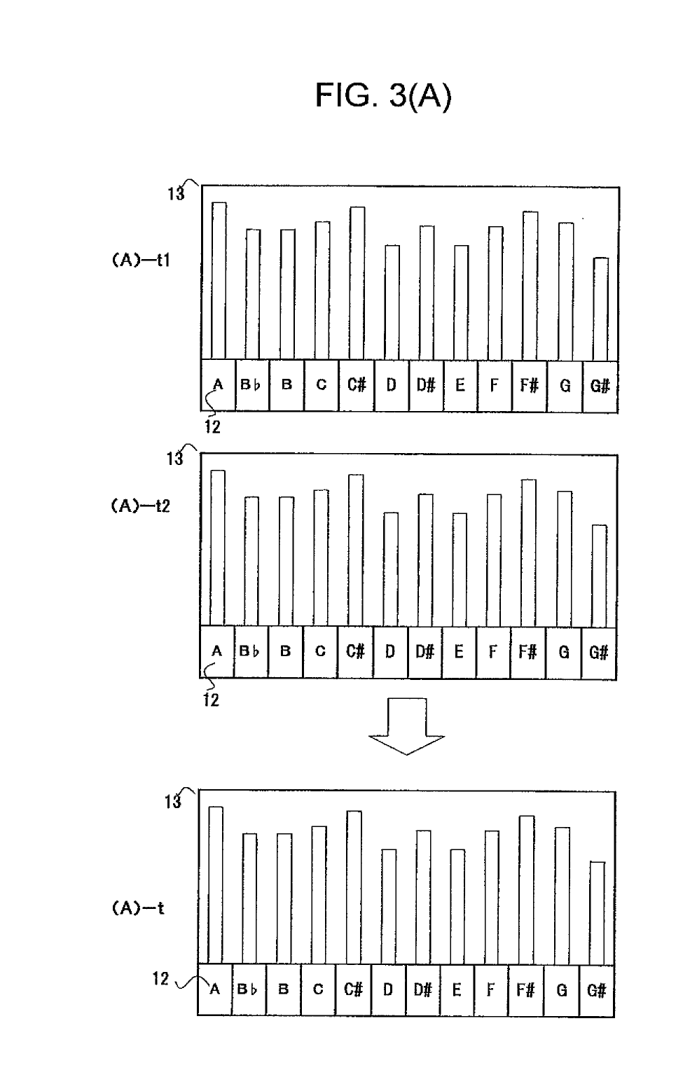

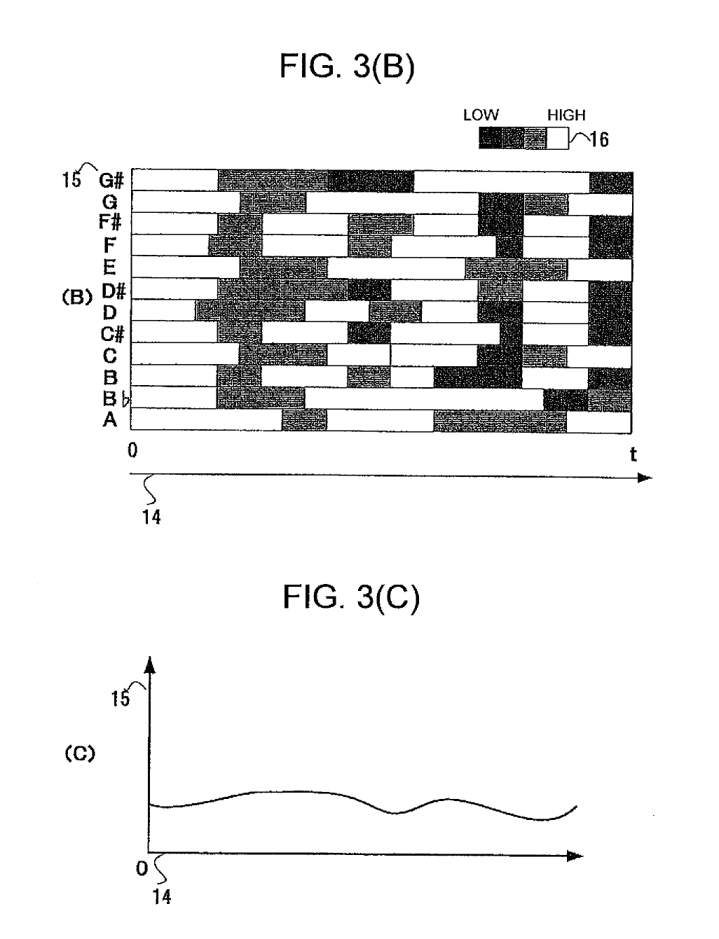

FIGS. 3(A) to (C) show the transition of the harmony clearness in the temporal axis. The abscissa axis and the ordinate axis of each of the diagrams are the same as those in FIGS. 2(A) to (C). It can be predicted from FIG. 3(B) that a standard deviation of the music interval power-additional level in the respective music intervals of the musical composition data is small. In the deviation of the harmony clearness of the musical composition data in the temporal axis in FIG. 3(C), the harmony clearness is kept as a small value.

After the calculation of the harmony clearness for the musical composition having no acoustically audible chords, the harmony clearness is indicated as a low value. It is confirmed that the musical composition having the low harmony clearness includes a combination of chords, which is not acoustically audible, and the above-described calculation results coincide with the impression of chords of the musical composition in an acoustic sense with which the musical composition is actually listened to.

It is possible to know the impression of the musical composition by calculating the transition of the harmony clearness of the musical composition data in the temporal axis. It is therefore possible to discriminate the impression of the musical composition to be “relaxing” or “distortional” by utilizing the calculation results of the transition of the harmony clearness of the musical composition data in the temporal axis.

### II) Best Mode for Carrying Out the Invention

Now, the best mode for carrying out the present invention will be described below with reference to the drawings. In each of the embodiments, the present invention is applied to an information reproduction/recording apparatus

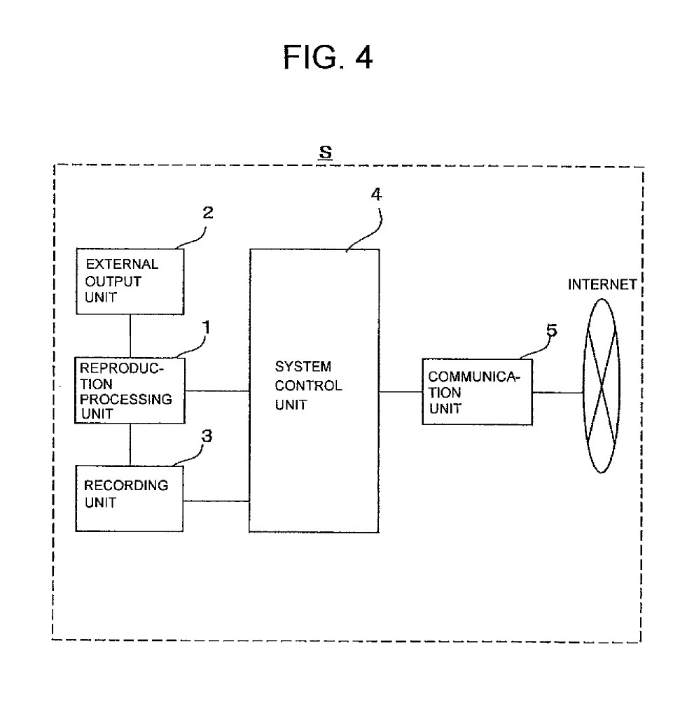

First, a configuration and a function of the information reproduction/recording apparatus according to this embodiment of the present invention will be described with reference to FIG. 4. FIG. 4 is a block diagram showing the general configuration example of an information reproduction apparatus.

The information reproduction/recording apparatus “S” includes a reproduction processing unit 1, an external output unit 2, a recording unit 3, a system control unit 4 and a communication unit 5, as shown in FIG. 4.

The reproduction processing unit 1 reproduces, under control of the system control unit 4, data of a musical composition, which are recorded in a recording medium such as a CD (Compact Disc), a MD (Mini Disc), a DVD (Digital Versatile Disc) or a card-type recording medium (e.g., a memory stick, a SD card, or the like), and outputs the data of the musical composition to the external output unit 2.

The external output unit 2, which is provided with a DSP (Digital Signal Processor), an amplifier, a loudspeaker and the like, causes the data of the musical composition, which have been reproduced by the reproduction processing unit 1, to be subjected to a known acoustic processing and audio-outputs the resultant signals outside through the amplifier and the loudspeaker.

The recording unit 3, which includes a recording mechanism such as a hard disc drive for example, compresses, under control of the system control unit 4, the data of the musical composition outputted from the reproduction processing unit 1 and records in the recording medium not only them in a predetermined file format, but also relevant information to the above-mentioned musical composition (e.g., a musical composition ID (identification information o the musical composition), a name of the musical composition, a title of an album in which the musical composition is recorded, etc.).

The data of the musical composition may be downloaded through the communication unit 7 together with their relevant information from for example a musical composition delivery server, which is connected to the Internet. The above-mentioned relevant information may be downloaded from a server, which has a CDDB (CD Data Base) as connected to the Internet with a key of a TOC (Table Of Contents) information corresponding to the respective data of the musical compositions.

The system control unit 4, which is provided with a CPU having a calculation function, a work RAM, a ROM for storing the various processing programs (including a display control program of the present invention) and the data, etc., causes the above-mentioned CPU to execute the program recorded in the ROM, etc., to make a general control of the information reproduction/recording apparatus “S”, thus controlling record and reproduction of the data of the musical composition. In addition, the system control unit 6 serves as a music interval power-additional level calculation unit, harmony clearness calculation unit, a lower beat level detection unit and a musical impression discrimination unit.

More specifically, the system control unit 6 calculates the music interval power-additional level from the musical composition data as inputted from the reproduction processing unit 1 or the recording unit 3, calculates the harmony clearness from the music interval power-additional level as calculated, and discriminates the impression of the musical composition based on the harmony clearness as calculated.

In addition, the system control unit 4 calculates, through the Fast Fourier Transform, a signal level (amplitude) power spectrum F(n) in a predetermined bandwidth (Hz) for the musical composition as inputted, and then calculates the respective music interval powers (Hz) from the calculation results. Then, the respective music interval powers are subjected to a weighting addition processing within a single octave, thus calculating a “music interval power-additional level”.

The system control unit 4 calculates a deviation within an octave (a difference from an average value of the respective music interval power-additional levels “ANP(p)” as calculated) from the “music interval power-additional level” as calculated by the music interval power-additional level calculation unit.

Further, the system control unit 4 utilizes the harmony clearness to discriminate the impression of the musical composition, although the detailed description thereof will be described later.

### First Embodiment

### Impression Discrimination Based on Harmony Clearness

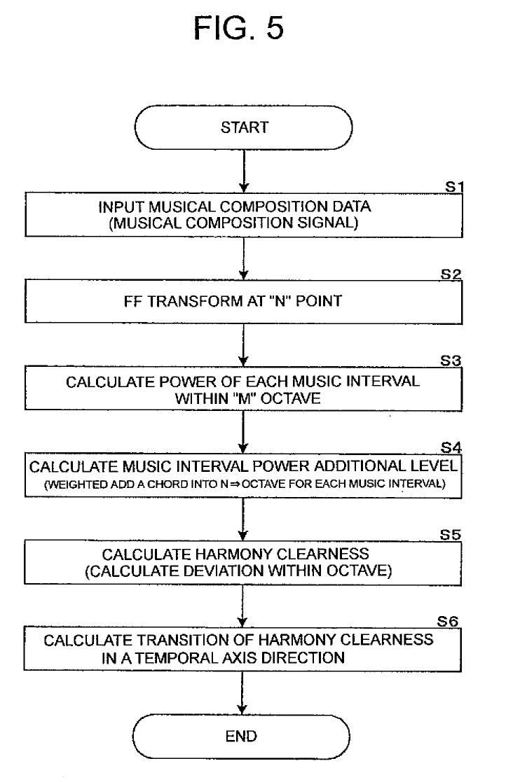

Now, an operation of the information reproduction/recording apparatus “S” according to this embodiment of the present invention will be described with reference to FIG. 4. FIG. 5 is a flowchart showing operation of the information reproduction apparatus “S”.

When the musical composition data are inputted from the reproduction processing unit 1 or the like (Step S1), the system control unit 4 causes the musical composition data to be subjected to the Fast Fourier Transform at N points (Step S2). Then, the power of the respective music interval within “M” octaves is calculated Step S3) and the music interval power-additional level is calculated (Step S4). Then, the harmony clearness is calculated (Step S5), and the transition of the harmony clearness in the temporal axis direction is finally calculated (Step S6).

Then, the impression of the musical composition is discriminated based on the harmony clearness as calculated. The impression of the musical composition as discriminated in this manner is stored in the recording unit 3 in for example a musical composition table so as to associated with the musical composition. Referring to the musical composition table when making a search of the musical composition causes the impression of the musical composition to be displayed so that a user may recognize it.

### Second Embodiment

### Impression Discrimination Based on Harmony Clearness and Lower Beat Level

Analysis of the musical composition utilizing not only the harmony clearness, but also an amount of the other characteristic feature, e.g., a lower beat level, makes it possible to discriminate in a detailed manner the impression of the musical composition.

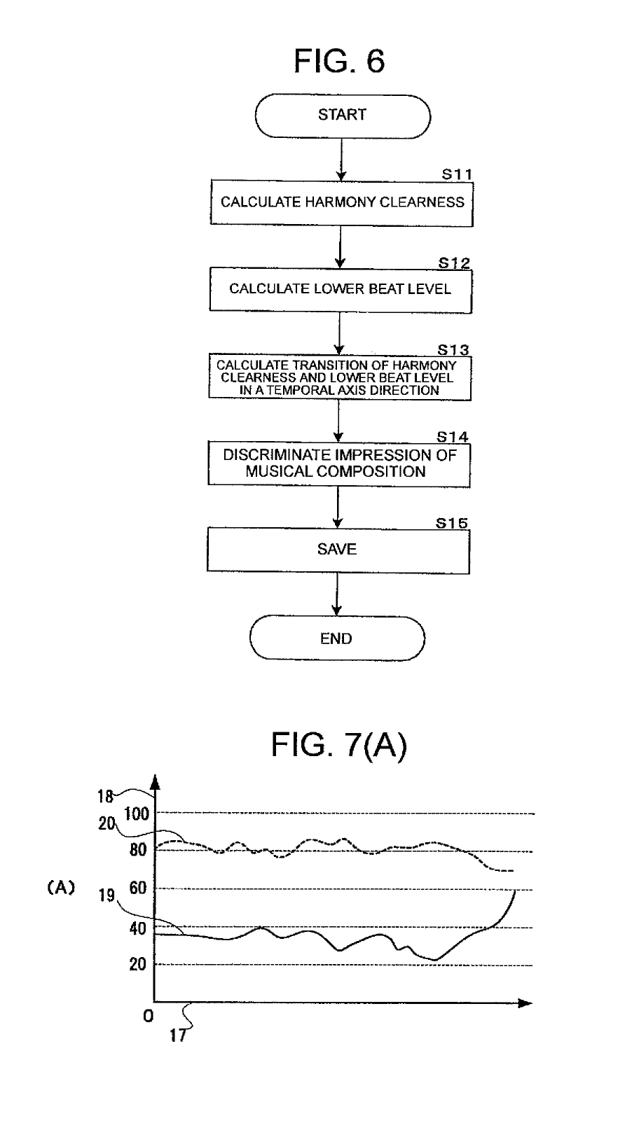

Description will be given below of the discrimination of the impression of the musical composition utilizing the harmony clearness and the lower beat level, with reference to FIGS. 6 to 8. FIG. 6 is a flowchart showing discrimination of an impression of the musical composition based on the harmony clearness and the lower beat level. There is used a relationship in which the lower beat level serving as the new index for the discrimination of the impression of the musical composition is added to the flowchart as shown in FIG. 5, which shows the operation of the information reproduction/recording apparatus “S”.

First, the harmony clearness is calculated in Step S11. Calculation of the harmony clearness is the same as shown in the flowchart as shown in FIG. 5, which shows the operation of the information reproduction/recording apparatus “S”.

Then, the lower beat level is calculated in Step S12. The lower beat level means a volume level of sounds making up a rhythm part of the musical composition, which is performed on a drum, a bass guitar or the like. In general, sounds making up a rhythm part of the musical composition, which is performed on a drum, a bass guitar or the like are a lower-pitched sound than the other sounds. The level of these sounds will be generally referred to as the “lower beat level”. The lower beat level is specifically of a low-frequency signal in music.

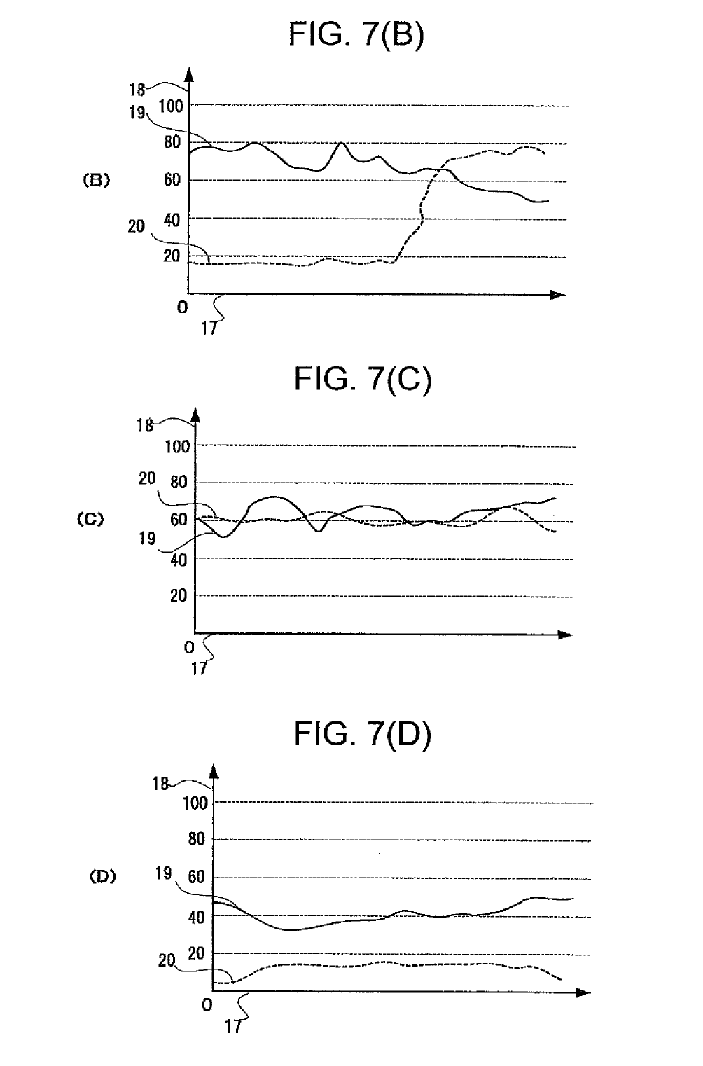

Then, transitions of the calculated harmony clearness and lower beat level in the temporal axis direction are calculated in Step S13. The calculation of the transitions in the temporal axis direction may be made for the whole musical composition, or a part thereof. FIGS. 7(A) to (D) show temporal variations of the harmony clearness and the lower beat level of four kinds of the musical compositions. The abscissa axis 17 of the graph indicates the temporal axis direction and the ordinate axis 18 thereof indicates transitions of the calculated harmony clearness and lower beat level in the temporal axis direction. The values in the ordinate axis, which are based on values as normalized with a predetermined value, are also normalized for the respective musical compositions as shown in FIGS. 7(A) to (D), so that these values may be relatively compared with each other in magnitude relation. A solid line 19 in the graph indicates the harmony clearness and a broken line 20 therein indicates the lower beat level.

The musical composition “A” as shown in FIG. 7(A) is acoustically recognized by a human as a rock music, which is exciting and of a good beat. When a discrimination of the impression of the musical composition “A” is made utilizing the harmony clearness and the lower beat level, it is recognized from the calculation that the harmony clearness of the musical composition “A” fluctuates in the vicinity of about “30”, and the lower beat level thereof fluctuates in the vicinity of about “80”. The harmony clearness is low and the lower beat level is high, resulting that the impression of the musical composition is discriminated as distortional.

Therefore, the impression as acoustically recognized of the musical composition coincides with the impression of the musical composition as discriminated by calculating the harmony clearness and the lower beat level.

The musical composition “B” as shown in FIG. 7(B) includes the first half, which is performed only on a piano and a vocal, with the result that the chords are acoustically audible. This musical composition includes the latter half having a rhythm part, which is performed on a drum, etc. The harmony clearness is kept as the very high value of about “80” into the first half of the musical composition, reflecting such a structure of the musical composition “B”. On the other hand, the lower beat level is kept as the low value of about “20” into the first half of the musical composition. The musical composition “B” has a beautiful harmony of chords between these values, thus giving an impression of calmness of the musical composition.

The performance of the rhythm part on the drum, etc. after the first half of the musical composition reverses the magnitude relation between the harmony clearness and the lower beat level. In FIG. 7(B), the line of the harmony clearness and the line of the lower beat level intersect one another, reversing the magnitude relation of them. After the first half of the musical composition, the lower beat level becomes higher, thus giving an impression of distortion of the musical composition. Therefore, the impression as acoustically recognized of the musical composition coincides with the impression of the musical composition as discriminated by calculating the harmony clearness and the lower beat level.

The musical composition “C” as shown in FIG. 7(C), which is formed by a band performance and includes many kinds of sound produces such as a vocal, a keyboard, a drum, a bass guitar and a guitar, gives a rhythmical impression in an acoustic sense. The harmony clearness of the musical composition “C” is relatively high of about “60” and the lower beat level is also relatively high of about “60”, thus gibing an easy-listening and rhythmical impression of the musical composition. Therefore, the impression as acoustically recognized of the musical composition coincides with the impression of the musical composition as discriminated by calculating the harmony clearness and the lower beat level.

The musical composition “D” as shown in FIG. 7(D), which is formed by a performance of a cappella only of a vocal, with the result that the chords are acoustically audible. The harmony clearness of the musical composition “D” is the similar value to the musical composition “A”, however, the lower beat level of the former is extremely lower than the musical composition “A”. Even if the harmony clearness has the similar value, it is possible to discriminate based on the value of the lower beat level that the impression of the musical composition is different from the musical composition “A”. Therefore, the impression as acoustically recognized of the musical composition coincides with the impression of the musical composition as discriminated by calculating the harmony clearness and the lower beat level.

The above reveals that consideration of the value of the lower beat level in addition to the harmony clearness in the discrimination of the impression of the musical composition permits to make a further classification of the impression of the musical composition, in the same manner as the acoustical recognition of the musical composition.

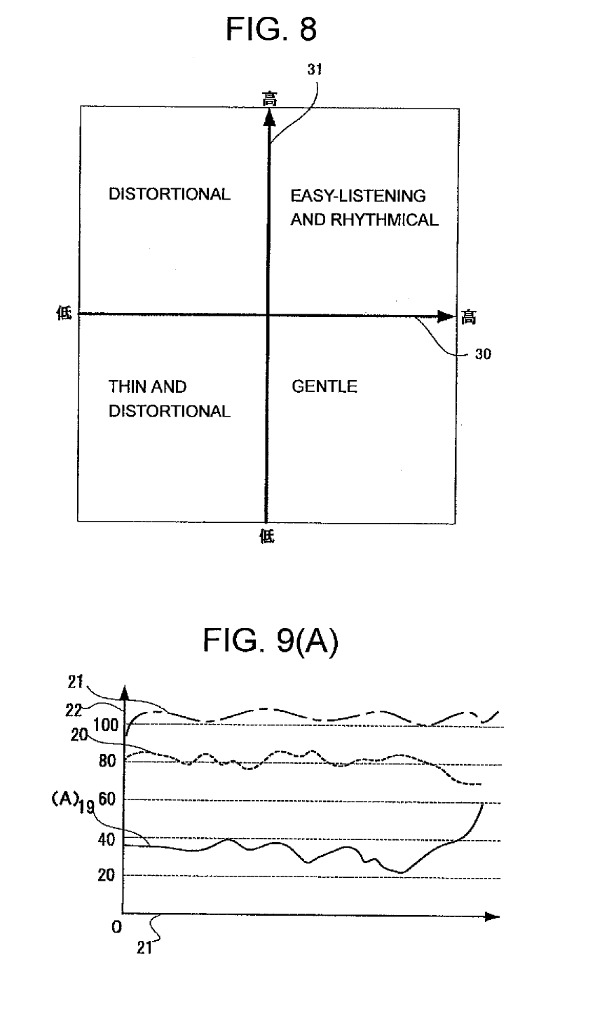

FIG. 8 is a drawing showing classified impressions utilizing the harmony clearness and the lower beat level. The abscissa axis 30 indicates the harmony clearness and the ordinate axis 31 indicates the lower beat level. The impression of the musical composition may be classified based on the harmony clearness and the lower beat level, as described above. As shown in FIG. 8, the musical composition having the relatively higher harmony clearness and lower beat level provides an easy-listening and rhythmical impression. The musical composition having the relatively high harmony clearness and the relatively low lower beat level provides a gentle impression. The musical composition having the relatively low harmony clearness and the relatively high lower beat level provides a distortional impression. The musical composition having the relatively low harmony clearness and the relatively low lower beat level provides a thin and distortional impression.

Analysis of the musical composition utilizing not only the harmony clearness, but also an amount of the other characteristic feature, e.g., the lower beat level, makes it possible to discriminate in a detailed manner the impression of the musical composition.

### III) Example of Transitions of Harmony Clearness and Lower Beat level in Temporal Axis Direction in Case Where Signal Power is Changed

The harmony clearness and the lower beat level serve as the index to discriminate the impression of the musical composition, as described above. Therefore, the harmony clearness and the lower beat level have to serve as the index to discriminate the impression of the musical composition, without being influenced by a signal power (dB) of the musical composition, i.e., a magnitude of a volume level of sounds upon reproduction. The above-mentioned hypothesis will be verified below.

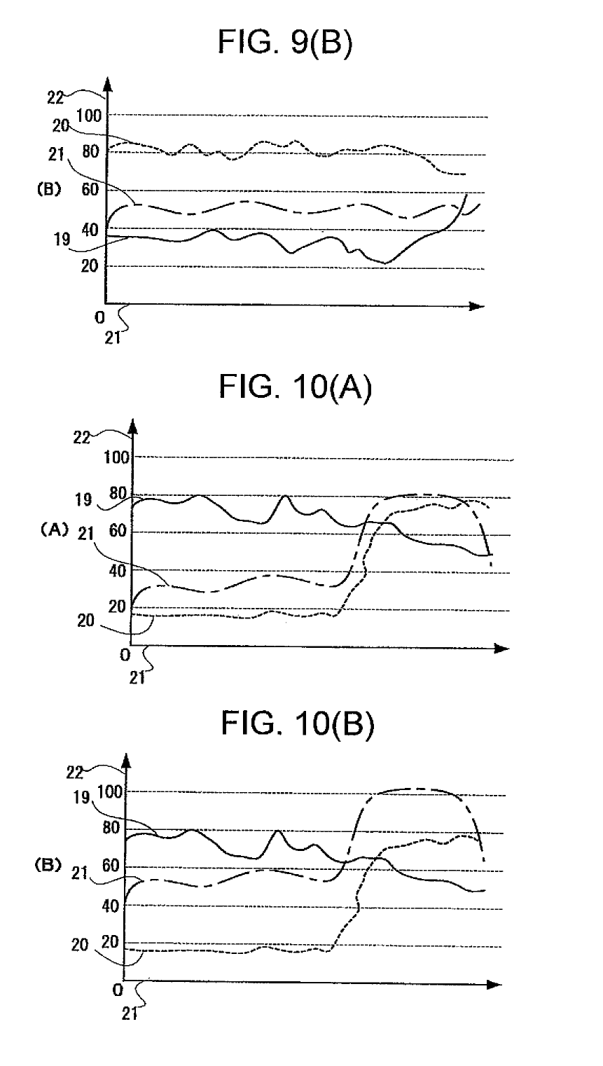

FIG. 9 shows an example of transitions of the harmony clearness and the lower beat level in the temporal axis direction in case where a signal power is reduced in the musical composition “A”. The abscissa axis 21 of the graph indicates the temporal axis direction, and the ordinate axis 22 indicates the transitions of the harmony clearness and the lower beat level in the temporal axis direction. The values in the ordinate axis, which are based on values as normalized with a predetermined value, are also normalized for the respective musical compositions as shown in FIGS. 9(A) and (B), so that these values may be relatively compared with each other in magnitude relation. A solid line 19 in the graph indicates the harmony clearness, a broken line 20 therein indicates the lower beat level and a dashed line 21 indicates the signal power.

The musical composition “A” is discriminated as described above as giving an distortional impression based on the calculation of the harmony clearness and the lower beat level. According to the hypothesis, the impression of the musical composition should not change depending on a magnitude of the signal power.

FIG. 9(A) shows values of the harmony clearness and the lower beat level in case where the musical composition “A” is reproduced with the signal power of about “100”. FIG. 9(B) shows values of the harmony clearness and the lower beat level in case where the signal power is decreased to half, i.e., about “50”. As shown in FIGS. 9(A) and (B), the values of the harmony clearness and the lower beat level do not substantially change. It can therefore be said that the reduced signal power has no influence on the values of the harmony clearness and the lower beat level, thus reflecting the impression of the musical composition. This reveals that the above-mentioned hypothesis has been verified.

FIG. 10 shows an example of transitions of the harmony clearness and the lower beat level in the temporal axis direction in case where the signal power is increased in the musical composition “B”.

The musical composition “B” is discriminated as described above as giving a calm impression in the first half of the musical composition “B”, but a distortional impression in the latter half thereof, based on the calculation of the harmony clearness and the lower beat level. The impression of the musical composition should not change depending on a magnitude of the signal power in the same manner as described above.

FIG. 10(A) shows values of the harmony clearness and the lower beat level in case where the musical composition “A” is reproduced with the signal power of about “20”. FIG. 10(B) shows values of the harmony clearness and the lower beat level in case where the signal power is increased to double, i.e., about “40”. As shown in FIGS. 10(A) and (B), the values of the harmony clearness and the lower beat level do not substantially change. It can therefore be said that the increased signal power has no influence on the values of the harmony clearness and the lower beat level, thus reflecting the impression of the musical composition. This reveals that the above-mentioned hypothesis has been verified.

According to the embodiment as described of the present invention, the chords are calculated from the musical composition data as imputed, the harmony clearness is calculated based on the chords as calculated, the impression of the musical composition is discriminated based on the calculated harmony clearness, etc., thus permitting an accurate discrimination of the impression of the musical composition and selection of the musical composition based on the impression thereof.

Observation of a temporal data of the harmony clearness enables a variation pattern of the musical composition to be read out. This makes it possible to search a musical composition having the similar enthusiasm or arrangement, or a musical composition having the quite different enthusiasm or arrangement.

It is possible to make an accurate discrimination of the impression of the musical composition, which may change in impression thereof during the performance, by calculating the harmony clearness of a part of the musical composition (e.g., a section having a stable temporal data such as an introduction or a hook-line) and discriminating the impression of the musical composition based on the harmony clearness as calculated.

Analysis of the musical composition utilizing not only the harmony clearness, but also an amount of the other characteristic feature, e.g., the lower beat level, makes it possible to discriminate in a detailed manner the impression of the musical composition, thus permitting selection of the musical composition based on the impression thereof.

If numerical data of the harmony clearness itself are classified into the respective levels and then stored in the form of metadata, it is possible to search the musical composition by selecting the harmony clearness itself.

Various kinds of methods may be applicable to determine the impression of the musical composition based on the harmony clearness, etc. Determination may be made based on subjective evaluation by many subjects. Determination may be made based on an arbitrary operation and decision of a user. Alternatively, the impression of the musical composition may be automatically determined based on historical data of reproduction of the musical composition by a user, or his/her evaluation thereof.

The present invention has been described as the embodiment in which the present invention was applied to the information reproduction/recording apparatus “S”. However, the present invention may be applied to the other apparatus such as a cellular phone, a personal computer, and the other car or home-use electronics.

1. A musical composition discrimination apparatus comprising:
a music interval power-additional level calculation unit that calculates a music interval power-additional level from musical composition data as inputted;
a harmony clearness calculation unit that calculates, based on a music interval power-additional level as calculated, a harmony clearness indicative of a degree as to whether a harmony is acoustically clearly audible or not; and
a musical impression discrimination unit that utilizes the harmony clearness to discriminate an impression of the musical composition, and
wherein:
said music interval power-additional level calculation unit utilizes a weighting coefficient to make a calculation of the music interval power-additional level, a value of said weighting coefficient in a high-frequency band of the musical composition data being smaller than that of another band;
said harmony clearness calculation unit utilizes a correction coefficient to make a calculation of the harmony clearness, said correction coefficient being set as a smaller value in case where a sum of music powers other than those of consonances is large.

2. The musical composition discrimination apparatus as claimed in claim 1, wherein:
said harmony clearness calculation unit calculates the harmony clearness based on deviation of the music interval power-additional level.

3. The musical composition discrimination apparatus as claimed in claim 1, wherein:
said music interval power calculation unit calculates the music interval power-additional level of a part of the musical composition; and
said harmony clearness calculation calculates the harmony clearness based on the music interval power-additional level of a part of the musical composition.

4. The musical composition discrimination apparatus as claimed in claim 1, further comprising:
a lower beat level detection unit that detects a lower beat level of the musical composition data; and
wherein:
said musical impression discrimination unit utilizes any one value of a value as calculated by the harmony clearness calculation unit and a value as detected by the lower beat level detection unit to discriminate the impression of the musical composition.

5. A musical composition discrimination method comprising:
a music interval power-additional level calculation step for calculating a music interval power-additional level from musical composition data as inputted;
a harmony clearness calculation step for calculating, based on a music interval power-additional level as calculated, a harmony clearness indicative of a degree as to whether a harmony is acoustically clearly audible or not; and
a musical impression discrimination step for utilizing the harmony clearness to discriminate an impression of the musical composition, and
wherein:
said music interval power-additional level calculation step utilizes a weighting coefficient to make a calculation of the music interval power-additional level, a value of said weighting coefficient in a high-frequency band of the musical composition data being smaller than that of another band;
said harmony clearness calculation step utilizes a correction coefficient to make a calculation of the harmony clearness, said correction coefficient being set as a smaller value in case where a sum of music powers other than those of consonances is large.

6. A non-transitory computer readable recording medium in which a musical composition discrimination program, which is to be executed by a computer included in a musical composition discrimination apparatus to cause the computer to function as:
a music interval power-additional level calculation unit that calculates a music interval power-additional level from musical composition data as inputted;
a harmony clearness calculation unit that calculates, based on a music interval power-additional level as calculated, a harmony clearness indicative of a degree as to whether a harmony is acoustically clearly audible or not; and
a musical impression discrimination unit that utilizes the harmony clearness to discriminate an impression of the musical composition, and
wherein:
said music interval power-additional level calculation unit utilizes a weighting coefficient to make a calculation of the music interval power-additional level, a value of said weighting coefficient in a high-frequency band of the musical composition data being smaller than that of another band;
said harmony clearness calculation unit utilizes a correction coefficient to make a calculation of the harmony clearness, said correction coefficient being set as a smaller value in case where a sum of music powers other than those of consonances is large.

7. (canceled)
